(19) United States
(12) Patent Application Publication
(10) Pub. No.: US 2023/0288976 A1
(43) Pub. Date: Sep. 14, 2023

(54) TASK MANAGEMENT DEVICE, TASK MANAGEMENT METHOD, AND TASK MANAGEMENT PROGRAM

(71) Applicant: Nippon Telegraph and Telephone Corporation, Tokyo (JP)

(72) Inventors: Katsumi FUJITA, Musashino-shi, Tokyo (JP); Masashi KANEKO, Musashino-shi, Tokyo (JP)

(21) Appl. No.: 18/019,274

(22) PCT Filed: Aug. 17, 2020
(86) PCT No.: PCT/JP2020/030996

§ 371 Date: Feb. 2, 2023

(51) Int. Cl. G06F 1/3228; G06F 9/48

(52) U.S. Cl. CPC G06F 1/3228; G06F 9/4818; G06F 9/4875

(57) ABSTRACT

A controller (10) includes: a power generation amount collection unit (15) that obtains an available power amount of a server group (21) from a power generation amount of a renewable power plant (3); a usage collection unit (13) that obtains a power usage of the server group (21); and a task control unit (14) that suspends a task in operation according to an insufficient amount of power and stops a server that has operated the suspended task when the available power amount is insufficient for the power usage. The task control unit (14) calculates a priority of each task operating in the server group (21), calculates a priority of each server in the server group (21) that operates each task from the priority of each task, and selects a server to be stopped in order from a server with a lower priority.

### TECHNICAL FIELD

The present invention relates to a task management device, a task management method, and a task management program.

### BACKGROUND ART

With the development and spread of technologies such as Internet of things (IoT), big data utilization, and automatic operation, the power consumption in data centers accounts for about 1% of the power consumption in the whole world, and is expected to further increase in the future. The data centers include servers equipped with different CPUs such as Intel (registered trademark) and Acorn RISC Machine (ARM) (registered trademark).

Therefore, Non Patent Literatures 1 and 2 describe a method for satisfying performance requirements with the power consumption suppressed by use of a scheduling technique for deploying (arranging) a virtual machine (VM) or a container on each server.

### CITATION LIST

### Non Patent Literature

Non Patent Literature 1: Rocha, Isabelly, et al. “HEATS: Heterogeneity- and Energy-Aware Task-based Scheduling.” 2019 27th Euromicro International Conference on Parallel, Distributed and Network-Based Processing (PDP). IEEE, 2019.
Non Patent Literature 2: Ismaeel, Salam, Ali Miri, and Ayman Al-Khazraji. “A novel host readiness factor for energy-efficient VM consolidation in cloud data centers.” 2019 8th International Conference on Modeling Simulation and Applied Optimization (ICMSAO). IEEE, 2019.

### SUMMARY OF INVENTION

### Technical Problem

Contamination of the global environment due to carbon dioxide emission during power generation has been regarded as a global problem. Therefore, a shift has been made from conventional thermal power generation using fossil fuels to power generation using renewable energy such as solar power generation and wind power generation, which have little influence on the environment.

Here, since the renewable energy depends on natural environments such as seasons and regions, the power generation amount is unstable. Therefore, a scheduling technique based on unstable power supply of the renewable energy is required.

However, since the conventional scheduling techniques such as Non Patent Literatures 1 and 2 assume stable power supply, it is not possible to cope with such an unstable power supply system that temporarily saves a task when the power is insufficient.

Therefore, a main object of the present invention is to appropriately arrange a task even when a power supply source is unstable.

### Solution to Problem

In order to solve the above problem, a task management device of the present invention has the following characteristics.

The present invention includes:
a power generation amount collection unit that obtains an available power amount of a server group from a power generation amount of a power feeding unit;
a usage collection unit that obtains a power usage of the server group; and
a task control unit that suspends a task in operation according to an insufficient amount of power and stops a server that has operated the suspended task when the available power amount is insufficient for the power usage.

### Advantageous Effects of Invention

According to the present invention, it is possible to appropriately arrange a task even when a power supply source is unstable.

### BRIEF DESCRIPTION OF DRAWINGS

FIG. 1 is a configuration diagram of a task processing system according to the present embodiment.

FIG. 2 is a hardware configuration diagram of a controller according to the present embodiment.

FIG. 3 is a flowchart illustrating processing of the controller according to the present embodiment.

FIG. 4 is a graph illustrating a relationship between an available power amount and a power usage according to the present embodiment.

FIG. 5 is a table illustrating an example of tasks initially arranged in a server group according to the present embodiment.

FIG. 6 is a table indicating a state after processing in a case where an insufficient amount of power is 100 [Wh] in Classification 3 according to the present embodiment.

FIG. 7 is a table indicating a state after processing in a case where the insufficient amount of power is 150 [Wh] in Classification 3 according to the present embodiment.

FIG. 8 is a table indicating a state after processing in a case where the insufficient amount of power is 200 [Wh] in Classification 3 according to the present embodiment.

FIG. 9 is a table indicating a state after processing in a case where the available power amount is recovered from the state of FIG. 8 according to the present embodiment and transitions to a power surplus state of Classification 1.

### DESCRIPTION OF EMBODIMENTS

Hereinafter, an embodiment of the present invention will be described in detail with reference to the drawings.

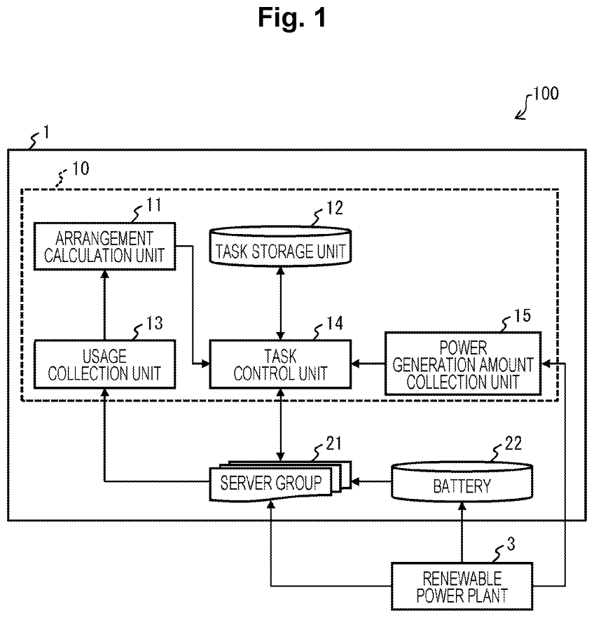

FIG. 1 is a configuration diagram of a task processing system 100.

The task processing system 100 includes a data center 1 and a renewable power plant (power feeding unit) 3 that feeds power to the data center 1. The renewable power plant 3 is an installation or facility that performs power generation using renewable energy, such as solar power generation or wind power generation.

The data center 1 includes a server group 21 that processes tasks, a battery 22 that feeds power to the server group 21 at the time of a power failure or the like of the renewable power plant 3, and a controller (task management device) 10 that allocates each task to a server included in the server group 21. A task is a processing unit of software that operates to provide a service. For example, a virtual machine (VM) or a container operating on a server is an example of a task.

The server group 21 is a set of servers to which each task is allocated, and each server may be a server different from the other servers. A different server means that hardware resources of the server, such as a CPU, a memory, and a storage, which are components of the device, are different from those of the other servers.

The controller 10 includes an arrangement calculation unit 11, a task storage unit 12, a usage collection unit 13, a task control unit 14, and a power generation amount collection unit 15.

The usage collection unit 13 collects, as statistical information, a resource (power) usage of each server in operation included in the server group 21. The usage collection unit 13 also calculates a free resource space of each server by subtracting the resource usage from a total resource amount of each server.

On the basis of the free resource space of each server obtained by the usage collection unit 13, the arrangement calculation unit 11 schedules on which server in the server group 21 each task should be deployed (reserved) at the start of a service to achieve the optimal arrangement.

The task storage unit 12 stores data of a task to be arranged by the arrangement calculation unit 11.

The power generation amount collection unit 15 constantly monitors a power generation amount of the renewable power plant 3 and collects the result as statistical information.

The task control unit 14 obtains an amount of power that is available for processing of a task from the collected power usage and power generation amount. Then, the task control unit 14 appropriately changes a task arrangement state and a server operation state according to the available power amount (or change in the power generation amount).

For example, when the available power amount decreases, the task control unit 14 stops a task having a low priority and a server that has operated the task according to an insufficient amount of power. On the other hand, when the available power amount increases, the task control unit 14 operates a task having a low priority on a server in addition to a task having a high priority.

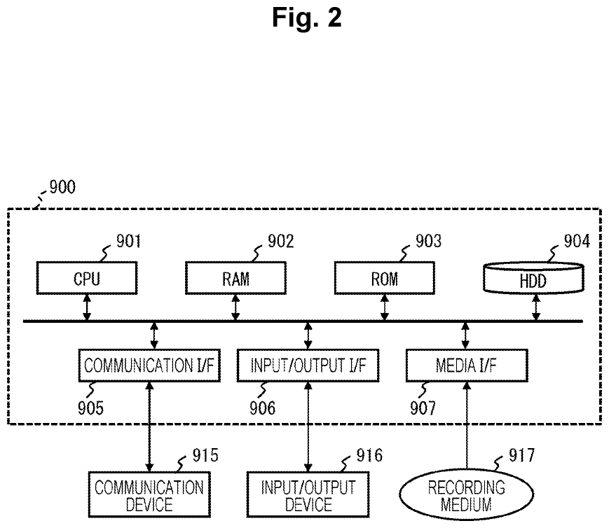

FIG. 2 is a hardware configuration diagram of the controller 10.

The controller 10 is configured as a computer 900 including a CPU 901, a RAM 902, a ROM 903, an HDD 904, a communication I/F 905, an input/output I/F 906, and a media I/F 907.

The communication I/F 905 is connected to an external communication device 915. The input/output I/F 906 is connected to an input/output device 916. The media I/F 907 reads and writes data from and to a recording medium 917. Moreover, the CPU 901 controls each processing unit by executing a program (also referred to as an application or an app for abbreviation thereof) read into the RAM 902. This program can be distributed via a communication line, or distributed by being recorded in the recording medium 917 such as a CD-ROM.

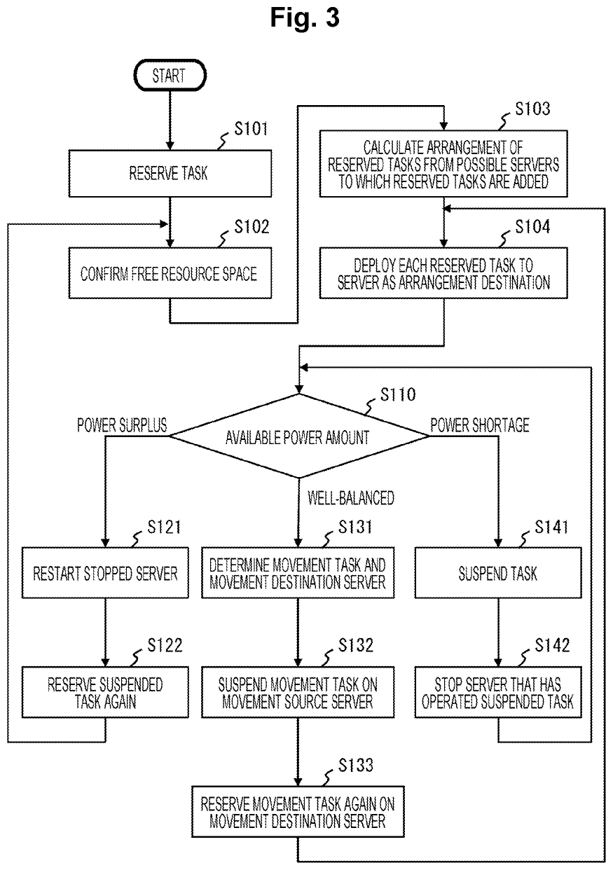

FIG. 3 is a flowchart illustrating processing of the controller 10.

The task control unit 14 reserves a task to be operated on each server in the server group 21 of the data center 1 (S101). As a result, unarranged tasks (reserved tasks) in the task storage unit 12 can be deployed at a reservation time (service start time).

When the current time reaches the reservation time, the usage collection unit 13 confirms the free resource space of each server (S102). The task control unit 14 sets a server having a margin in the confirmed free resource space as a possible server to which a task is added.

The arrangement calculation unit 11 calculates the arrangement of the reserved tasks suitable for the free resource spaces of possible servers (S103). In the calculation of S103, the arrangement calculation unit 11 may apply an optimal arrangement search technique using an approach by linear regression, neural network, or the like.

The task control unit 14 deploys each of the reserved tasks to a server as an arrangement destination on the basis of the calculation result of S103 (S104).

As described above, the initial arrangement of the tasks is completed by the series of processing of S101 to S104. However, since the power generation amount of the renewable power plant 3 changes from moment to moment, processing of optimizing the arrangement of tasks according to the power generation amount monitored by the power generation amount collection unit 15 will be described from S110.

From the power generation amount of the renewable power plant 3 collected by the power generation amount collection unit 15, the task control unit 14 obtains the amount of power that can be used by the server group 21 for processing the tasks (hereinafter, “available power amount”), for example, by the following equation.

(Available power amount)=(Power generation amount of renewable power plant 3)−(Power usage of facilities of data center 1 other than server group 21, such as controller 10)−(Power usage stored in battery 22)

Next, the task control unit 14 compares the calculated available power amount with the power usage of the server group 21 collected by the usage collection unit 13 to classify the current power feeding situation as follows (S110).
(Classification 1) In a case of the available power amount>>the power usage, the current power feeding situation is determined as “power surplus”, and the processing proceeds to S121.
(Classification 2) In a case of the available power amount≈the power usage, the current power feeding situation is determined as “well-balanced”, and the processing proceeds to S131.
(Classification 3) In a case of the available power amount<<the power usage, the current power feeding situation is determined as “power shortage”, and the processing proceeds to S141.

Note that the power usage of the server group 21 is a statistical value of a power amount required at the time of operation of the servers (the sum of the power amounts of all the servers), and is measured as, for example, an average value, a mode value, or a minimum value. In addition, in a case where the available power amount<<the power usage (=the minimum value) is satisfied in Classification 3, the power shortage is particularly serious, and thus the storage of the battery 22 is desirably used as a reserve power supply.

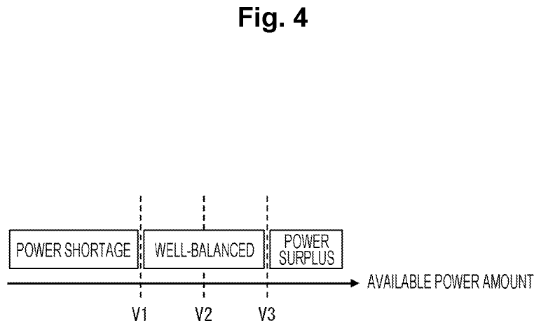

FIG. 4 is a graph illustrating a relationship between the available power amount and the power usage. The horizontal axis represents the available power amount, and the value increases toward the right. In addition, the average value of the power usage of the server group 21 is V2 on the graph.

In a case where the available power amount is V3 or more, the available power amount greatly exceeds V2, and thus the task control unit 14 determines “power surplus” of Classification 1.

In a case where the available power amount is V1 or more and less than V3, the excess or deficiency from V2 is small, and thus the task control unit 14 determines “well-balanced” of Classification 2.

In a case where the available power amount is less than V1, the available power amount is significantly less than V2, and thus the task control unit 14 determines “power shortage” of Classification 3.

Here, a threshold (V3−V2) and a threshold (V2−V1) based on V2 are calculated from the variance of the average value of the power usage of the server group 21, and the threshold (V2−V1)>the threshold (V3−V2).

Hereinafter, referring back to FIG. 3, processing in which the task control unit 14 appropriately changes the task arrangement state and the server operation state according to each classification will be specifically described.

(Classification 3) Processing in the case of “power shortage” will be described.

The task control unit 14 suspends a service of a task corresponding to the insufficient amount of power (=power usage−available power amount), and takes a snapshot of the current state of the suspended task and temporarily stores the snapshot in the task storage unit 12 (S141). As a result, even if a server that has operated the suspended task is stopped, the current state of the task is not lost.

The task control unit 14 then reduces the power usage and improves the “power shortage” state by stopping the server having no task to be operated due to the task suspension processing of S141 (S142). The processing of stopping the server in S142 is not limited to processing of turning off the power supply, and may be processing of reducing the power usage such as shifting to a sleep state. The task control unit 14 then returns the processing to S110.

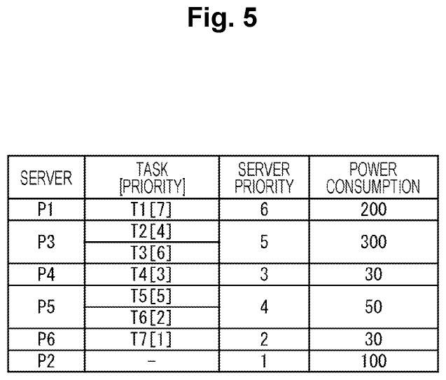

Here, which task is suspended by the task control unit 14 in S141 and which server is stopped by the task control unit 14 in S142 will be clarified in specific examples after FIG. 5.

(Classification 1) Processing in the case of “power surplus” will be described.

The task control unit 14 restarts the server stopped by executing the processing of S142 (S121). As a result, a task can be deployed on the restarted server. The task control unit 14 then reads the task suspended by executing the processing of S141 from the task storage unit 12, and reserves the task again so that the task operates on the server restarted in S121 (S122).

At the execution time of the another reservation, the task reserved again is read from the task storage unit 12 and deployed on the server. As a result, the deployed task is deleted from the task storage unit 12. The task control unit 14 then returns the processing to S102.

(Classification 2) Processing in the case of “well-balanced” will be described. In the case of “well-balanced”, since the excess or deficiency of the power amount is small, there is no need to urgently change the task arrangement state or the server operation state. Therefore, the task control unit 14 may omit processing of optimizing the task arrangement described in following S131 to S133.

The arrangement calculation unit 11 calculates arrangement of tasks suitable for the free resource spaces of possible servers (S131). Note that the processing of searching for the optimal arrangement of tasks is common between S103 and S131. On the other hand, in S103, a server as an arrangement destination is determined for an unarranged reserved task, but in S131, an arranged task is set as a movement task to be migrated (moved), and a server to which the movement task is moved is determined.

The task control unit 14 suspends the movement task operating on a movement source server and saves the movement task in the task storage unit 12 (S132). The task control unit 14 then reads the movement task being saved from the task storage unit 12, and reserves the movement task again so that the movement task operates on the movement destination server (S133). The task control unit 14 then returns the processing to S104.

Hereinafter, the task arrangement state and the server operation state will be specifically described with reference to FIGS. 5 to 9.

FIG. 5 is a table illustrating an example of tasks initially arranged in the server group 21. In this table, for each server, a currently arranged task, the priority of the task, the priority of the server according to the priority of the task, and the power consumption of the server are associated with each other.

Note that the power that can be collected as the power consumption of a server is the sum of the power consumption at the time of idling and the power consumption associated with processing of each task. In addition, both a task and a server are prioritized as the numerical value of the priority thereof is larger, and are less likely to be stopped even when the power is insufficient because the task and the server are an important task and server.

For example, on a server P1, a task T1 with a priority=7 (highest) is operating, and the power consumption of the server P1 is 200 [Wh] in the entire server. Meanwhile, on a server P3, a task T2 with a priority=4 and a task T3 with a priority=6 are operating, and the power consumption of the server P3 is 300 [Wh] in the entire server. Furthermore, on a server P2, no task is operating, but the server itself is powered on, and the power consumption of the server P2 is 100 [Wh].

That is, since the power consumption of the servers P1 to P3 is high (100 or more), the processing capacity is high, but the power efficiency is poor. Since the power consumption of servers P4 to P6 is low (50 or less), the processing capacity is low, but the power efficiency is good.

First, the task control unit 14 calculates the priority of each task operating on each server. For example, one or a combination of following parameters can be used as an input parameter for calculating the priority.
An input parameter indicating a utilization rate of the task (service). For example, the higher the CPU utilization rate of the server or the memory utilization rate of the server, the higher the task priority.
An input parameter indicating an urgency estimated from a requirement required for a task (service). For example, the stricter the required response time or real-time processability, the higher the task priority.

The task control unit 14 then acquires the highest value of the priorities of tasks operating on each server, and assigns a higher server priority as the highest value is higher. For example, the highest value of the priorities of the tasks on the server P3 is MAX(4, 6)=6, and thus a server priority=5, which is next to the server priority=6 of the server P1 (task priority=7), is assigned.

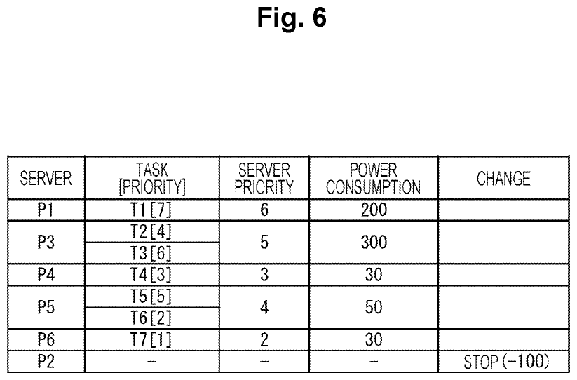

FIG. 6 is a table indicating a state after processing in a case where the insufficient amount of power is 100 [Wh] in Classification 3.

The table of FIG. 6 has the same format as the table of FIG. 5, and a column of “change” for description is added to the rightmost column. This column of “change” indicates contents of change from the state of FIG. 5.

The task control unit 14 adds the power consumption of a server in ascending order of the server priority until the power consumption is equivalent to the insufficient amount of power. In the example of FIG. 5, since the server P2 having the lowest server priority=1 has power consumption=100, the task control unit 14 only needs to stop the server P2.

The task control unit 14 temporarily stores the task on the server P2 to be stopped in the task storage unit 12 (S141), but there is no task on the server P2 this time, and thus the processing of S141 is omitted. The task control unit 14 then reduces the power usage by the insufficient amount of power 100 [Wh] by stopping the server P2 (S142).

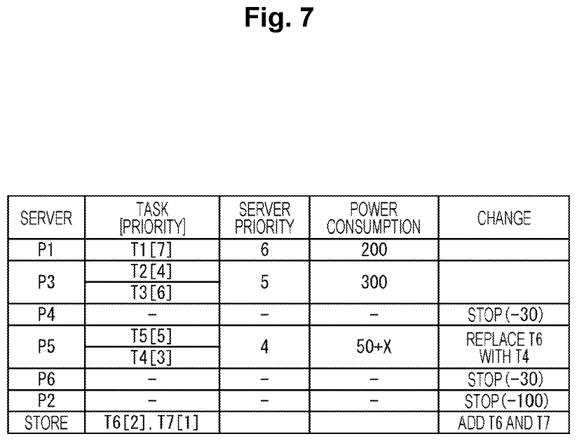

FIG. 7 is a table indicating a state after processing in a case where the insufficient amount of power is 150 [Wh] in Classification 3.

The task control unit 14 adds the power consumption of a server in ascending order of the server priority until the power consumption is equivalent to the insufficient amount of power. In the example of FIG. 5, since the total power consumption of the servers P2, P6, and P4, which have lower three server priorities, is 160 [Wh], the task control unit 14 stops the three servers.

The task control unit 14 temporarily stores a task T7 on the server P6 to be stopped in the task storage unit 12 (S141). Similarly, the task control unit 14 may temporarily store a task T4 on the server P4 to be stopped in the task storage unit 12, but may perform task replacement processing as follows.
(Procedure 1) A server that is not to be stopped this time is searched for. Here, a server P5 with low power consumption and high power efficiency has been searched for.
(Procedure 2) A task T6 having a task priority lower than the task T4 to be replaced is found out from among tasks (operating tasks) operating on the server P5.
(Procedure 3) After the task T6 on the server P5 is temporarily stored in the task storage unit 12, the task T4 is migrated (moved) to the server P5. By the replacement processing between the tasks T6 and T4, the power consumption of the server P5 slightly increases by X from 50, but this slight increase is considered to be much smaller than the power consumption of the server itself and is ignored in the following calculation of the power consumption.

Note that, in the present specification, since it is assumed that up to two tasks operate simultaneously for each server, the processing of saving the task T6 in Procedure 3 is performed first, so that a free space for one task is prepared on the server P5. Meanwhile, if the server P1 is selected in Procedure 1 with emphasis on processing performance, it is not necessary to save another task because the server P1 originally has a free space for one task.

The task control unit 14 then reduces the power usage by the insufficient amount of power 160 [Wh] by stopping the servers P2, P6, and P4 having no operating task (S142).

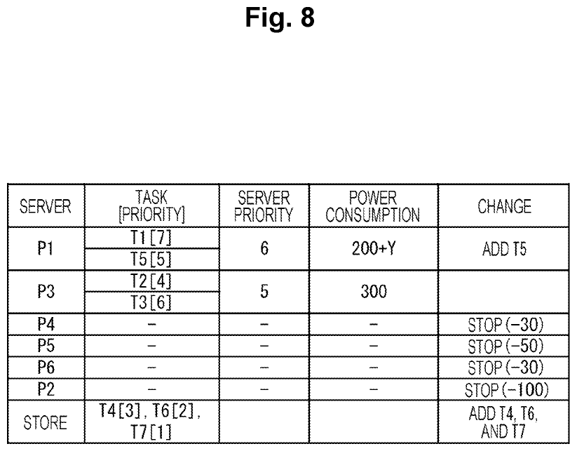

FIG. 8 is a table indicating a state after processing in a case where the insufficient amount of power is 200 [Wh] in Classification 3.

The task control unit 14 adds the power consumption of a server in ascending order of the server priority until the power consumption is equivalent to the insufficient amount of power. In the example of FIG. 5, since the total power consumption of the servers P2, P6, P4, and P5, which have lower four server priorities, is 210 [Wh], the task control unit 14 stops the four servers.

The task control unit 14 temporarily stores the following operating tasks in the task storage unit 12 (S141).
The task T7 on the server P6 to be stopped
The task T4 on the server P4 to be stopped
asks T5 and T6 on the server P5 to be stopped

Thereafter, the task control unit 14 moves the task T5 having the highest task priority in the task group stored in the task storage unit 12 to the server P1 having a free space for one task. As a result, the power consumption of the server P5 slightly increases by Y from 200.

The task control unit 14 then reduces the power usage by the insufficient amount of power 210 [Wh] by stopping the servers P2, P6, P4, and P5 having no operating task (S142).

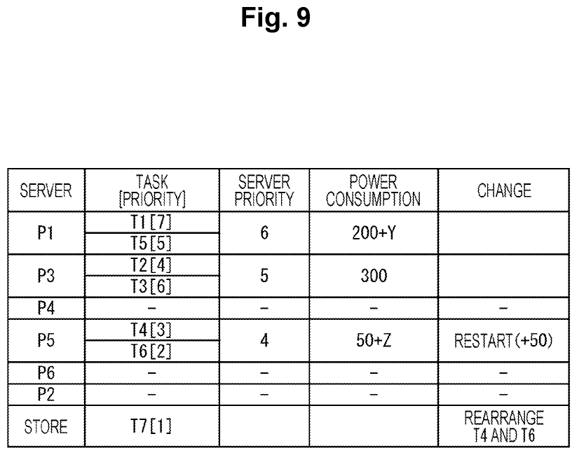

FIG. 9 is a table indicating a state after processing in a case where the available power amount is recovered from the state of FIG. 8 and transitions to the power surplus state of Classification 1.

The task control unit 14 restarts the stopped server P5 (S121). The task control unit 14 then reads, from the task storage unit 12, the tasks T4 and T6 each having a higher task priority among the suspended tasks T4, T6, and T7, and reserves the tasks again so that the tasks operate on the server P5 (S122). As a result, the operating tasks can be appropriately increased according to the available power amount.

### [Effects]

A controller (task management device) 10 of the present invention includes:
a power generation amount collection unit 15 that obtains an available power amount of a server group 21 from a power generation amount of a renewable power plant (power feeding unit) 3;
a usage collection unit 13 that obtains a power usage of the server group 21; and
a task control unit 14 that suspends a task in operation according to an insufficient amount of power and stops a server that has operated the suspended task when the available power amount is insufficient for the power usage.

With this configuration, it is possible to appropriately arrange a task even when a power supply source is unstable. For example, using the renewable power plant 3 as an unstable power supply source makes it possible to obtain the effect of reducing carbon dioxide emission, which contributes to improvement of global environmental problems. In addition, the present invention is not limited to the renewable power plant 3, and even in a case where a stable power supply source is used in normal operation, service provision can be continued at the time of disaster such as power failure.

The task control unit 14 calculates a priority of each task operating in the server group 21 by use of a predetermined input parameter, calculates a priority of each server in the server group 21 that operates each task from the priority of each task, and selects a server to be stopped in order from a server with a lower priority.

With this configuration, even when the power is insufficient, it is possible to continue the operation with a task with a high priority operating.

The task control unit 14 migrates a task on a server to be stopped this time to a server not to be stopped this time.

With this configuration, it is possible to shorten the service suspension period of the task to be migrated.

The task control unit 14 saves, in a task storage unit 12, a snapshot obtained when a task on a server to be stopped this time is suspended.

With this configuration, since the current state of the suspended task is also stored, it is not necessary to discard the previous calculation result.

The task control unit 14 restarts the stopped server and rearranges the task saved in the task storage unit 12 on the restarted server when the available power amount is recovered for the power usage.

With this configuration, it is possible to operate a task of an appropriate load according to the available power amount, and the resource utilization efficiency is improved.

### REFERENCE SIGNS LIST

1 Data center
3 Renewable power plant (power feeding unit)
10 Controller (task management device)
11 Arrangement calculation unit
12 Task storage unit
13 Usage collection unit
14 Task control unit
15 Power generation amount collection unit
21 Server group
22 Battery
100 Task processing system

1. A task management device comprising:
a power generation amount collection unit, including one or more processors, configured to obtain an available power amount of a server group from a power generation amount of a power feeding unit;
a usage collection unit, including one or more processors, configured to obtain a power usage of the server group; and
a task control unit, including one or more processors, configured to suspend a task in operation according to an insufficient amount of power and stop a server that has operated the suspended task when the available power amount is insufficient for the power usage.

2. The task management device according to claim 1, wherein
the task control unit is configured to calculate a priority of each task operating in the server group by use of a predetermined input parameter, calculate a priority of each server in the server group that operates each task from the priority of each task, and select a server to be stopped in order from a server with a lower priority.

3. The task management device according to claim 1, wherein
the task control unit is configured to migrate a task on a server to be stopped this time to a server not to be stopped this time.

4. The task management device according to claim 1, wherein
the task control unit is configured to save, in a task storage unit, a snapshot obtained when a task on a server to be stopped this time is suspended.

5. The task management device according to claim 4, wherein
the task control unit is configured to restart the stopped server and rearrange the task saved in the task storage unit on the restarted server when the available power amount is recovered for the power usage.

6. A task management method executed by a task management device, the task management method comprising:
obtaining an available power amount of a server group from a power generation amount of a power feeding unit;
obtaining a power usage of the server group; and
suspending a task in operation according to an insufficient amount of power and stopping a server that has operated the suspended task when the available power amount is insufficient for the power usage.

7. A non-transitory computer-readable storage medium storing a task management program for causing a computer to function as a task management device to perform operations comprising:
obtaining an available power amount of a server group from a power generation amount of a power feeding unit;
obtaining a power usage of the server group; and
suspending a task in operation according to an insufficient amount of power and stopping a server that has operated the suspended task when the available power amount is insufficient for the power usage.

8. The task management method of claim 6, further comprising:
calculating a priority of each task operating in the server group by use of a predetermined input parameter;
calculating a priority of each server in the server group that operates each task from the priority of each task; and
selecting a server to be stopped in order from a server with a lower priority.

9. The task management method of claim 6, further comprising:
migrating a task on a server to be stopped this time to a server not to be stopped this time.

10. The task management method of claim 6, further comprising:
saving, in a task storage unit, a snapshot obtained when a task on a server to be stopped this time is suspended.

11. The task management method of claim 10, further comprising:
restarting the stopped server and rearranging the task saved in the task storage unit on the restarted server when the available power amount is recovered for the power usage.

12. The non-transitory computer-readable storage medium of claim 7, wherein the operations further comprise:
calculating a priority of each task operating in the server group by use of a predetermined input parameter;
calculating a priority of each server in the server group that operates each task from the priority of each task; and
selecting a server to be stopped in order from a server with a lower priority.

13. The non-transitory computer-readable storage medium of claim 7, wherein the operations further comprise:
migrating a task on a server to be stopped this time to a server not to be stopped this time.

14. The non-transitory computer-readable storage medium of claim 7, wherein the operations further comprise:
saving, in a task storage unit, a snapshot obtained when a task on a server to be stopped this time is suspended.

15. The non-transitory computer-readable storage medium of claim 14, wherein the operations further comprise:
restarting the stopped server and rearranging the task saved in the task storage unit on the restarted server when the available power amount is recovered for the power usage.
